(19) United States
(12) Patent Application Publication
(10) Pub. No.: US 2006/0028758 A1
(43) Pub. Date: Feb. 9, 2006

(54) Magnetic recording and reproducing apparatus

(75) Inventors: Masatoshi Sakurai, Tokyo (JP); Akira Kikitsu, Yokohama-shi (JP); Makoto Asakura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/197,534

(22) Filed: Aug. 5, 2005

(30) Foreign Application Priority Data
Aug. 6, 2004 (JP) 2004-230940

(51) Int. Cl. G11B 17/00

(52) U.S. Cl. 360/97.01

(57) ABSTRACT

A magnetic recording and reproducing apparatus has a magnetic recording media having discrete tracks formed of concentric magnetic patterns and a head slider having a read/write head. When the head slider is located on an outermost recording zone of the magnetic recording media, a visual angle for the head slider as viewed from a rotation center of the magnetic recording media is 5° or more.

### CROSS-REFERENCE TO RELATED APPLICATIONS

This application is based upon and claims the benefit of priority from prior Japanese Patent Application No. 2004-230940, filed Aug. 6, 2004, the entire contents of which are incorporated herein by reference.

### BACKGROUND OF THE INVENTION

1. Field of the Invention

The present invention relates to a magnetic recording and reproducing apparatus having discrete track-type magnetic recording media.

2. Description of the Related Art

In recent years, much attention has been paid to a discrete track recording media in which adjacent recording tracks are separated from one another by guard bands consisting of a groove or a nonmagnetic material to suppress the magnetic interference between the adjacent tracks. When such a discrete track media is manufactured, forming both magnetic patterns constituting recording tracks and magnetic patterns corresponding to signals for servo zones by imprinting with a stamper will reduce costs, because such a method can eliminate servo track writing.

Conventionally, a magnetic disk has been known in which protruded and recessed patterns are formed on the surface of a substrate and a magnetic layer is formed on the surface thereof to form data recording zones (Japanese Patent No. 2,972,138). This document does not describe a disk size but describes that a head width is approximately 1 mm and that a magnetic disk is rotated at, for example, 3,600 rpm to cause a head slider to fly.

However, in magnetic recording apparatuses having a discrete track media, their read/write characteristics may be degraded by a factor different from that in the case of a magnetic recording media in which a continuous-film magnetic layer is formed. Accordingly, specifications for the magnetic recording apparatuses having a discrete track media to achieve good read/write characteristics have not been established.

When the present inventors have performed read/write experiments on magnetic recording apparatuses comprising a discrete track media, it has been found that a degraded error rate may be given depending on the position of a head slider on the magnetic disk and also head crash may be occurred in the worst case.

### BRIEF SUMMARY OF THE INVENTION

A magnetic recording and reproducing apparatus according to an aspect of the present invention comprises: a magnetic recording media having discrete tracks formed of concentric magnetic patterns; and a head slider having a read/write head, wherein, when the head slider is located on an outermost recording zone of the magnetic recording media, a visual angle for the head slider as viewed from a rotation center of the magnetic recording media is 5° or more.

A magnetic recording and reproducing apparatus according to another aspect of the present invention comprises a magnetic recording media having discrete tracks formed of concentric magnetic patterns; and a head slider having a read/write head, wherein, when the head slider is located on an innermost recording zone of the magnetic recording media, a visual angle for the head slider as viewed from a rotation center of the magnetic recording media is 10° or more.

In the present invention, the visual angle for the head slider as viewed from the rotation center of the magnetic recording media means the angle between two straight lines linking the rotation center of the magnetic recording media and the respective ends of the head slider.

### BRIEF DESCRIPTION OF THE SEVERAL VIEWS OF THE DRAWING

FIG. 1 is a schematic plan view of a magnetic disk according to an embodiment of the present invention;

FIG. 2 is a perspective view showing a data zone in a magnetic disk according to an embodiment of the present invention;

FIG. 3 is a schematic diagram showing a servo zone and a data zone in a magnetic disk according to an embodiment of the present invention;

FIG. 4 is a plan view showing patterns in a servo zone and a data zone in a magnetic disk according to an embodiment of the present invention;

FIG. 5 is a perspective view of a magnetic recording and reproducing apparatus according to an embodiment of the present invention;

FIG. 6 is a block diagram of a magnetic recording and reproducing apparatus according to an embodiment of the present invention;

FIG. 7 is a block diagram showing a control mechanism for head positioning for an magnetic recording and reproducing apparatus according to an embodiment of the present invention;

FIG. 8 is a block diagram showing an address processing unit in a channel in a magnetic recording and reproducing apparatus according to an embodiment of the present invention;

FIG. 9 is a plan view showing that a head slider is located on the outermost recording track;

FIG. 10 is a diagram showing the direction of the head slider located at the outermost position with respect to recording tracks, as well as wind pressure and rotation moment applied to the head slider;

FIG. 11 is a plan view showing that the head slider is located on the innermost recording track;

FIG. 12 is a diagram showing the direction of the head slider located at the innermost position with respect to recording tracks, as well as wind pressure and rotation moment applied to the head slider; and

FIG. 13 is a diagram showing the relationship between the position of the head slider on the magnetic disk and the skew angles of an arm and the head slider.

### DETAILED DESCRIPTION OF THE INVENTION

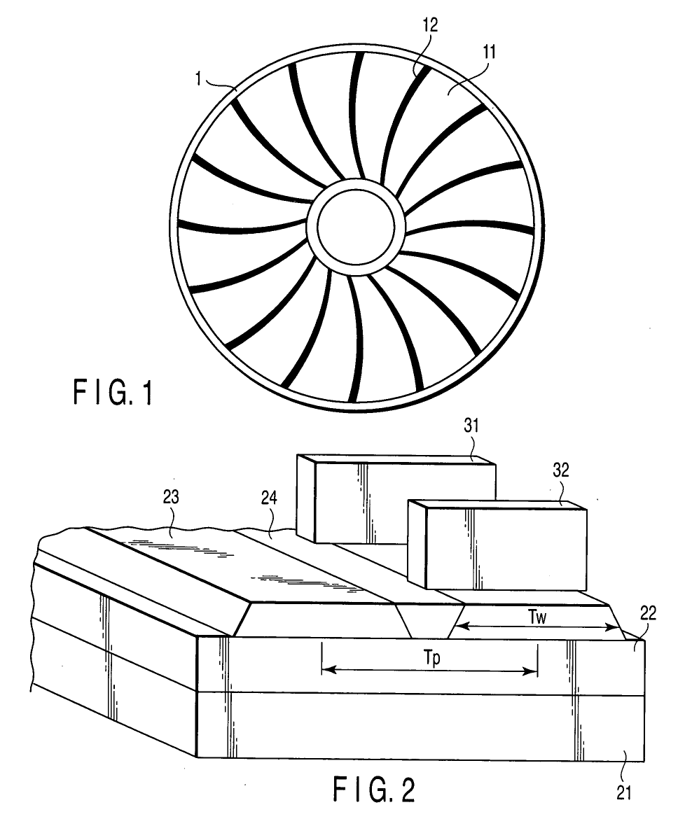

A magnetic disk according to an embodiment of the present invention will be described with reference to FIGS. 1 to 4.

FIG. 1 is a schematic plan view of a magnetic disk 1 according to an embodiment of the present invention. FIG. 1 shows data zones 11 and servo zones 12. User data is recorded in each of the data zones 11. This magnetic disk is a so-called DTR (discrete track recording) media having discrete tracks formed of concentric magnetic patterns. The recording tracks will be described later with reference to FIG. 2. Servo data for head positioning is formed in each of the servo zones 12 as patterns of a magnetic material and a nonmagnetic material. On the disk surface, the servo zone 12 is shaped like a circular arc corresponding to a locus of a head slider during access. The servo zone 12 is formed so that its circumferential length is larger as its radial position is closer to its outermost periphery.

FIG. 2 is a perspective view of a data zone in a magnetic disk according to an embodiment of the present invention. A soft underlayer 22 is formed on a substrate 21. Magnetic patterns constituting the recording tracks 23 and guard bands 24 made of a nonmagnetic material are alternately formed along a radial direction, and thus the recording tracks 23 are separated by the guard bands 24. The radial width and track pitch of the recording track 23 are denoted as Tw and Tp, respectively. The radial width Tw is formed to be larger than the width of the guard band 24. In the present embodiment, the ratio of the magnetic material to the nonmagnetic material in the radial direction is 2:1, that is, the occupancy rate of the magnetic material is set to 67%. A GMR element 31 of a read head and a single pole 32 of a write head, which are formed in the head slider, are positioned above the recording track 23.

As the substrate 21, a flat glass substrate is used. The substrate 21 is not limited to the glass substrate but an aluminum substrate may be used. As the ferromagnetic material forming the recording track 23, CoCrPt is used. As the guard band 24, nonmagnetic SiO₂ is used to fill the grooves that separate CoCrPt. The guard bands 24 may be the grooves themselves into which no material is filled. In FIG. 2, SiO₂ is filled into the grooves between the recording tracks 23 and then SiO₂ is flattened, thereby forming the guard bands 24. Although not shown, a protective film of diamond-like carbon (DLC) is formed on the surfaces of the recording tracks 23 and guard bands 24. Lubricant is then applied to the surface of the protective film. If SiO₂ is not filled into the grooves between the recording tracks 23, the protect layer is formed directly on the protruded and recessed surfaces of the recording tracks 23.

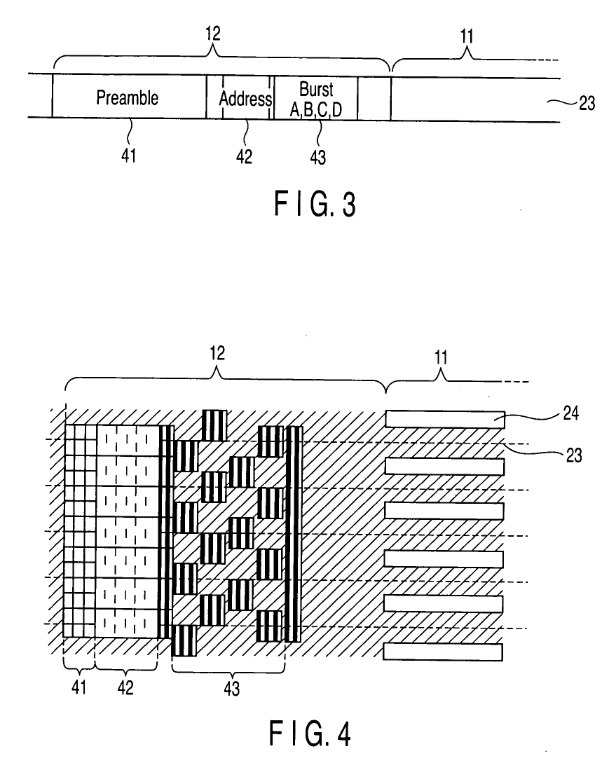

With reference to FIGS. 3 and 4, the patterns of the servo zone and data zone will be described. As schematically shown in FIG. 3, the servo zone 12 includes a preamble section 41, an address section 42, and a burst section 43 for detecting deviation.

As shown in FIG. 4, the data zone 11 includes the recording tracks 23 formed of magnetic patterns, and the guard bands 24 made of a nonmagnetic material. Patterns of the magnetic and nonmagnetic materials which provide servo signals are formed in each of the preamble section 41, address section 42, and burst section 43 in the servo zone 12. These sections have the functions described below.

The preamble section 41 is provided to execute a PLL process for synthesizing a clock for a servo signal read relative to deviation caused by rotational deflection of the media, and an AGC process for maintaining appropriate signal amplitude. The preamble section 41 has patterns of the magnetic and nonmagnetic materials substantially constituting circular arcs without being separated in the radial direction and repeatedly formed in the circumferential direction. The area ratio of the magnetic material to nonmagnetic material in the preamble section 41 is approximately 1:1, that is, the occupancy rate of the magnetic material is approximately 50%.

The address section 42 has servo signal recognition codes called servo marks, sector data, cylinder data, and the like formed at the same pitch as that of the preamble section 41 in the circumferential direction using Manchester encoding. In particular, since the cylinder data has a pattern exhibiting a data varied for every servo track, it is recorded using Manchester encoding after being converted into Gray codes providing the minimum difference between adjacent tracks so as to reduce the adverse effect of address reading errors during a seek operation. Also in the address section 42, the occupancy rate of the magnetic material is approximately 50%.

The burst section 43 is an off-track detecting region used to detect the amount of off-track with respect to the on-track state for a cylinder address. The burst section 43 has four fields of burst marks (called an A, B, C, and D bursts), whose pattern phases in a radial direction are shifted to each other in respective fields. Plural marks are arranged at the same pitch as that of the preamble section in the circumferential direction. The radial period of each burst is proportional to the period at which the address pattern changes, in other words, the servo track period. According to the present embodiment, respective bursts are formed in a length of 10 periods in the circumferential direction. The bursts are repeated in the radial direction in a period twice as long as the servo track period. In the burst section 43, the occupancy rate of the magnetic material is approximately 75%.

Each of the marks in the burst section 43 is designed to be a rectangle, or more precisely, a parallelogram taking the skew angle during head access into account. The mark may be slightly rounded depending on precision in stamper processing or processing performance for transfer formation and the like. The principle of detection of a position on the basis of the burst section 43 will not be described in detail. The off-track amount is obtained by calculating the average amplitude value of read signals from the A, B, C, and D bursts.

A process for manufacturing a magnetic disk according to an embodiment of the present invention will be briefly described. The steps of manufacturing a magnetic disk include a transfer step, a magnetic material processing step, and a finishing step.

Before describing these steps, a method of manufacturing a stamper used for the transfer step will be described. The process of manufacturing the stamper is subdivided into drawing, development, electroplating, and finishing. In the pattern drawing, an electron beam resist is applied to a master plate. An electron beam drawing apparatus with master plate rotation is used to draw patterns corresponding to the nonmagnetic sections of the magnetic disk from the inner periphery to the outer periphery. The electron beam resist is developed. Then, the master plate is processed by RIE or the like to form a master plate with protruded and recessed patterns. The surface of the master plate is made conductive by depositing a Ni thin film. The master plate is subjected to Ni electroplating. Then, the electroplated film is stripped. The back surface of the electroplated film is polished to adjust film thickness and to flatten the film. Finally, the inner and outer diameters of the film are punched out to produce a disk-shaped Ni stamper. In the stamper, protruded portions correspond to the nonmagnetic portions in the magnetic disk.

In the transfer step, an imprinting apparatus of double-sided co-transfer type is used to carry out imprinting lithography. Specifically, a soft underlayer and a perpendicular recording layer are deposited on each side of the disk substrate, and then an SOG (spin-on-glass) resist is applied to each side. The disk substrate is sandwiched between two stampers for the back and front surfaces. They are uniformly pushed to transfer the protruded and recessed patterns of the stamper to the resist surface. The recesses in the resist formed during the transfer step correspond to the nonmagnetic portions in the magnetic disk.

In the magnetic material processing step, the resist residue at the bottom of each recess is removed to expose the surface of the magnetic material. In this stage, SiO₂ remains on portions where the magnetic material is to be left. This SiO₂ is used as a mask to etch the exposed magnetic material by ion milling to form desired magnetic patterns. An SiO₂ film of a sufficient thickness is deposited by sputtering. Then, the SiO₂ film is reverse-sputtered to the surface of the magnetic layer to flatten the recesses between the magnetic patterns with the filled nonmagnetic material.

In the finishing step, the surface of the disk is polished, and then a DLC protective layer is formed. Further, a lubricant is applied to the protective layer. A magnetic disk according to the embodiment of the present invention is manufactured by these steps.

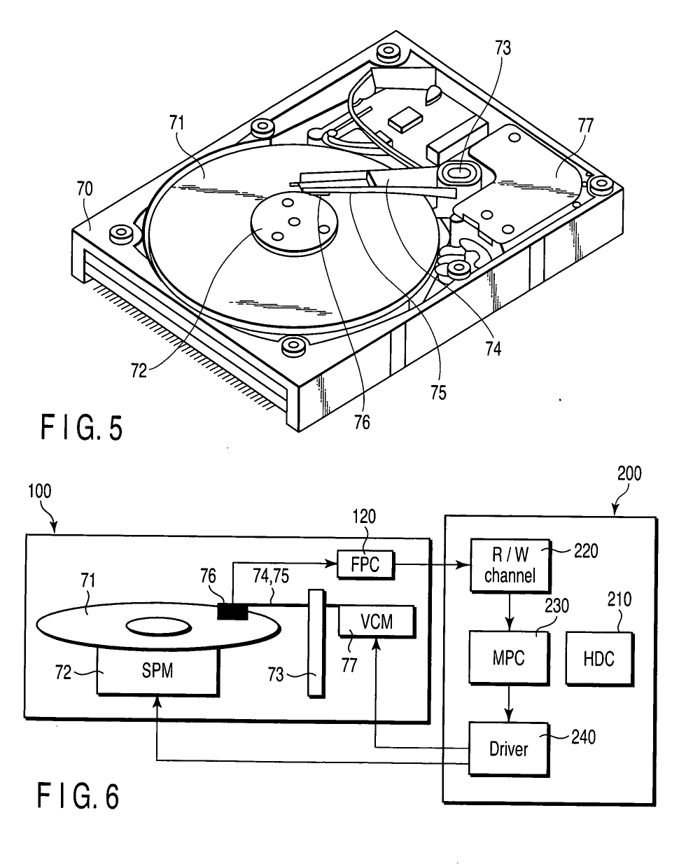

FIG. 5 is a perspective view of a magnetic recording and reproducing apparatus (hard disk drive) according to an embodiment of the present invention. The magnetic recording and reproducing apparatus comprises, inside a chassis 70, a magnetic disk 71, a head slider 76 including a read head and a write head, a head suspension assembly (a suspension 75 and an actuator arm 74) that supports the head slider 76, a voice coil motor (VCM) 77 and a circuit board.

The magnetic disk (discrete track media) 71 is mounted on and rotated by a spindle motor 72. Various digital data are recorded on the magnetic disk 71 in perpendicular magnetic recording manner. The magnetic head incorporated in the head slider 76 is a so-called integrated head including a write head of a single pole structure and a read head using a shielded MR read element (such as a GMR film or a TMR film). The suspension 75 is held at one end of the actuator arm 74 to support the head slider 76 so as to face the recording surface of the magnetic disk 71. The actuator arm 74 is attached to a pivot 73. The voice coil motor (VCM) 77, which serves as an actuator, is provided at the other end of the actuator 74. The voice coil motor (VCM) 77 drives the head suspension assembly to position the magnetic head at an arbitrary radial position of the magnetic disk 71. The circuit board comprises a head IC to generate driving signals for the voice coil motor (VCM) and control signals for controlling read and write operations performed by the magnetic head.

FIG. 6 shows a block diagram of the magnetic recording and reproducing apparatus (hard disk drive) according to an embodiment of the present invention. This figure shows the head slider only above the top surface of the magnetic disk. However, the perpendicular magnetic recording layer with discrete tracks is formed on each side of the magnetic disk as described above. A down head and an up head are provided above the bottom and top surfaces of the magnetic disk, respectively.

The disk drive includes a main body unit called a head disk assembly (HDA) 100 and a printed circuit board (PCB) 200.

As shown in FIG. 6, the head disk assembly (HDA) 100 has the magnetic disk (discrete track media) 71, the spindle motor 72, which rotates the magnetic disk, the head slider 76, including the read head and the write head, the suspension 75 and actuator arm 74, the voice coil motor (VCM) 77, and a head amplifier (HIC), which is not shown. The head slider 76 is provided with the read head including the GMR element 31 and the write head including the single pole 32, which are shown in FIG. 2.

The head slider 76 is elastically supported by a gimbal provided on the suspension 75. The suspension 75 is attached to the actuator arm 74, which is rotatably attached to the pivot 73. The voice coil motor (VCM) 77 generates a torque around the pivot 73 for the actuator arm 74 to move the head in the radial direction of the magnetic disk 71. The head amplifier (HIC) is fixed to the actuator arm 74 to amplify input signals to and output signals from the head. The head amplifier (HIC) is connected to the printed circuit board (PCB) 200 via a flexible print cable (FPC) 120. Providing the head amplifier (HIC) on the actuator arm 74 enables to reduce noise in the head signals effectively. However, the head amplifier (HIC) may be fixed to the HDA main body.

As described above, the perpendicular magnetic recording layer is formed on each side of the magnetic disk 71, and the servo zones each shaped like a circular arc are formed so as to correspond to the locus of the moving head. The specifications of the magnetic disk meet outer and inner diameters and read/write characteristics adapted to a particular drive. The radius of the circular arc formed by the servo zone is given as the distance from the pivot to the magnet head element.

Four major system LSIs are mounted on the printed circuit board (PCB) 200. The system LSIs are a disk controller (HDC) 210, a read/write channel IC 220, a MPU 230, and a motor driver IC 240.

The MPU 230 is a control unit of a driving system and includes ROM, RAM, CPU, and a logic processing unit which implement a head positioning control system according to the present embodiment. The logic processing unit is an arithmetic processing unit composed of a hardware circuit to execute high-speed calculations. Firmware (FW) for the logic processing circuit is saved to the ROM. The MPU controls the drive in accordance with FW.

The disk controller (HDC) 210 is an interface unit in the hard disk drive which manages the whole drive by exchanging information with interfaces between the disk drive and a host system (for example, a personal computer) and with the MPU, read/write channel IC, and motor driver IC.

The read/write channel IC 220 is a head signal processing unit relating to read/write operations. The read/write channel IC 220 is composed of a circuit which switches the channels of the head amplifier (HIC) and which processes read/write signals in read/write operations.

The motor driver IC 240 is a driver unit for the voice coil motor (VCM) 77 and spindle motor 72. The motor driver IC 240 controls the spindle motor 72 so that the motor 72 can rotate at a constant speed and provides a current, which is determined based on a VCM manipulating variable from the MPU 230, to VCM 77 to drive the head moving mechanism.

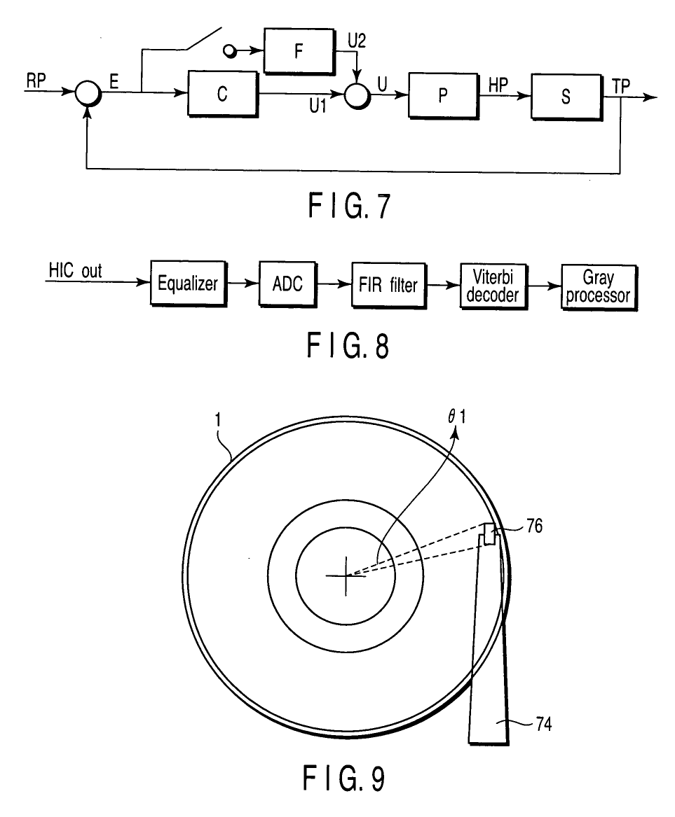

A control mechanism for head positioning will be described with reference to FIG. 7. This figure is a block diagram showing head positioning. The symbols C, F, P, and S mean system transfer functions. The control target P specifically corresponds to head moving means including VCM. The signal processing unit S is specifically implemented by the read/write channel IC and MPU (executing a part of off-track detection processing).

The control processing unit is composed of a feedback control unit C (first controller) and a synchronism compensating unit F (second controller). The control processing unit is specifically implemented by MPU.

Operations of the signal processing unit S will be described later in detail. The signal processing unit S generates information on the current track position (TP) on the disk on the basis of read signals from a servo zone on the disk immediately below the head position (HP).

On the basis of the positional deviation (E) between a target track position (RP) on the disk and the current position (TP) of the head on the disk, the first controller outputs a FB operation value U1 that reduces the positional deviation.

The second controller is a FF compensating unit that compensates for the shapes of the tracks on the disk and vibration that occurs in synchronism with the rotation of the disk. The second controller saves pre-calibrated rotation synchronization compensating values to a memory table. The second controller normally makes reference to the table on the basis of servo sector information (not shown) provided by the signal processing unit S to output an FF operation value U2 without use of positional deviation (E).

The control processing unit adds the outputs U1 and U2 of the first and second controllers to supply a control operation value U to VCM 77 via the disk controller (HDC) 210 to drive the head.

The synchronization compensating value table is calibrated during an initializing operation. When the positional deviation (E) becomes equal to or larger than a set value, a re-calibrating process is started to update the synchronization compensating value.

A method for detecting a positional deviation from read signals of a servo zone will be briefly described. The magnetic disk is rotated by the spindle motor at a constant rotation speed. The head slider is designed to be elastically supported by the gimbal provided on the suspension and to retain a very small flying height balancing with air pressure resulting from the rotation of the magnetic disk. Thus, the GMR element, included in the read head, detects a leakage flux from the recording layer of the magnetic disk across a predetermined magnetic spacing. The rotation of the magnetic disk causes each servo zone in the magnetic disk to pass immediately below the head at a constant period. A servo process can be executed by detecting track position information on the basis of read signals from the servo zone.

Upon finding an identification flag for the servo zone called a servo mark, the disk controller (HDC) can predict timing when the servo zone passes immediately below the head on the basis of the periodicity of the servo zone. Thus, the disk controller (HDC) causes the channel to start a servo process at a time when the preamble section will pass immediately below the head.

With reference to the block diagram in FIG. 8, an address reproducing process in the channel will be described. Read output signals from the head amplifier IC (HIC) are loaded into the channel IC and subjected to an analog filtering process (longitudinal signal equalizing process) by an equalizer, and then sampled as digital values by an analog-to-digital converter (ADC).

A leakage flux from the magnetic disk according to the present embodiment is a perpendicular field corresponding to the magnetic patterns. However, all DC offset components are removed from the leakage flux by high-pass characteristics of the head amplifier (HIC) and the longitudinal equalizing process by the equalizer in the earlier stage of the channel IC. As a result, an output signal from the preamble section after the analog filtering process becomes an almost pseudo sine wave. The only difference from the signal obtained from the conventional perpendicular magnetic recording media is that the signal amplitude is reduced by half.

In the case where the polarity of the head is set inappropriately, the bit “1” or “0” may be mistakenly recognized depending on the direction of the leakage flux from the servo zone, causing the channel to fail in code detection, which is applied to not only the discrete track media according to the present embodiment but also another media. Accordingly, the polarity of the head must be appropriately set in accordance with the patterned leakage flux.

The channel IC switches the process in accordance with read signal phases. Specifically, the channel IC executes, for example, a process of pulling into synchronism of synchronizing a read signal clock with a media pattern period, an address reading process of reading sector and cylinder data, and a burst process for detecting the off-track amount.

The process of pulling into synchronism will be described briefly. In this process, a process of synchronizing timing for ADC sampling with sinusoidal read signals and an AGC process of matching the signal amplitude of digital sampling values at a certain level are executed. The periods of the bits 1 and 0 of the media pattern are sampled at four points.

In the address reading process, the sampling values are subjected to noise reduction in FIR, and then converted into sector and track data by the Viterbi decoding process, based on maximum likelihood estimation, or the Gray code inverse transformation process. This makes it possible to acquire servo track information of the head.

Then, the channel shifts to the process of detecting the off-track amount in the burst section. This process is not illustrated but proceeds as follows. Signal amplitudes are subjected to samplehold integration in the order of the burst signal patterns A, B, C, and D. A voltage value corresponding to the average amplitude is output to MPU. A servo process interruption is then issued to MPU. Upon receiving the interruption, MPU uses the internal ADC to load the burst signals in a time series manner. DSP then converts the signals into an off-track amount. The servo track position of the head is precisely detected on the basis of the off-track amount and the servo track information.

With reference to FIGS. 9 to 12, the position of the head slider and the corresponding visual angle for the head slider in the magnetic recording apparatus configured as described above will be described. In the discrete track media, the protrusions and recesses on the surface thereof cannot be completely eliminated even by a flattening process. It is thus likely to be difficult to control the flying of the head slider. In particular, the control of flying of the head slider is difficult if no nonmagnetic material is filled into the recesses between the magnetic patterns.

FIG. 9 is a plan view showing that the head slider 76 is located on the outermost recording track. In this case, let 01 be the visual angle for the head slider 76 as viewed from the center of the magnetic disk 1. FIG. 11 is a plan view showing that the head slider 76 is located on the innermost recording track. In this case, let θ₂ be the visual angle for the head slider 76 as viewed from the center of the magnetic disk 1.

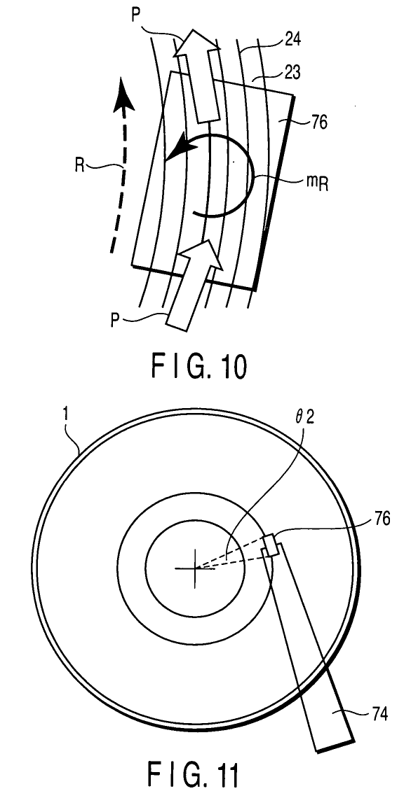

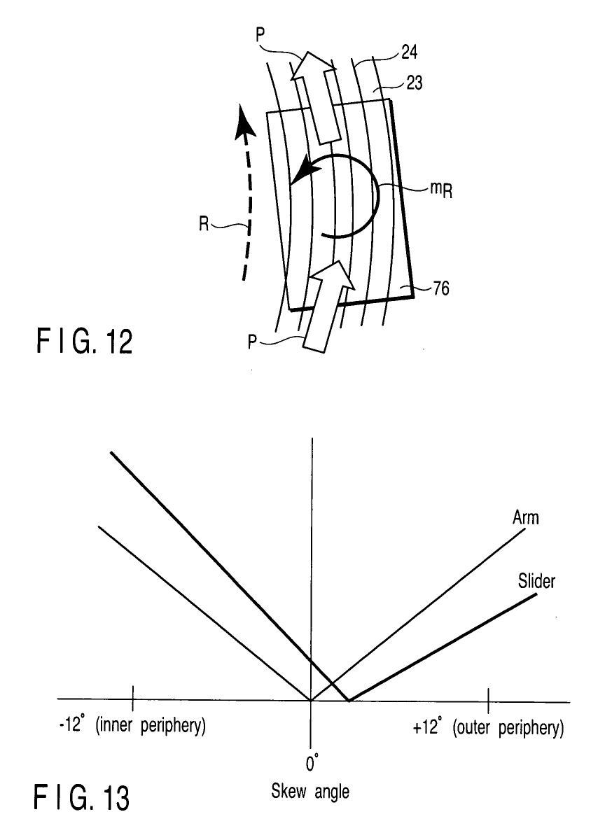

FIGS. 10 and 12 are diagrams showing the directions of the head slider 76 located as shown in FIGS. 9 (outermost position) and 11 (innermost position), respectively, with respect to the recording tracks 23, as well as wind pressure and rotation moment applied to the head slider 76. A dashed arrow R denotes the rotating direction of the magnetic disk. The symbol P denotes the direction of the wind pressure exerted on the head slider 76. The symbol m_{R} denotes the rotation moment applied to the head slider 76. The direction of the rotation moment m_{R} corresponds to the rotating direction R of the magnetic disk 71. The rotation moment applied to the head slider 76 bends the head slider 76 in the same direction as that of rotation of the magnetic disk 71, with respect to the direction of the arm 74.

FIG. 13 is a diagram showing the relationship between the position of the head slider on the magnetic disk and the skew angles of the arm and the head slider.

If the head slider 76 is located on the outermost recording track as shown in FIG. 9, then it receives the rotation moment m_{R} as shown in FIG. 10 and is thus bent in a direction that the skew angle of the slider is more reduced than that of the arm (FIG. 13). In an outer peripheral portion, the linear velocity of the magnetic disk 71 tends to become higher and to increase the wind pressure P and thus the flying height of the slider. However, the smaller skew angle of the slider reduces the wind pressure exerted on the slider. This makes it possible to suppress an increase in flying height and thus in error rate. As described below, to produce such an effect, it is necessary to set the visual angle θ₁ of the head slider 76 located in the outer peripheral portion, to 5° or more.

If the head slider 76 is located on the innermost recording track as shown in FIG. 11, then the linear velocity of the magnetic disk 71 becomes lower to reduce the flying height of the head slider 76. As a result, the possibility of head crash becomes high. On the other hand, when the head slider 76 is located on the innermost recording track, the visual angle θ₂ of the head slider is larger than the visual angle θ₁ when it is located on the outermost recording track. This increases the rotation moment mR applied to the head slider 76. In this case, the head slider 76 receives a large rotation moment mR as shown in FIG. 12 and is thus bent in a direction that the skew angle of the slider is more increased than that of the arm (FIG. 13). The larger skew angle of the slider increases the wind pressure exerted on the slider. Consequently, in spite of a low linear velocity of the magnetic disk 71, a sufficient flying height can be maintained for the slider. This makes it possible to prevent an increase in error rate caused by contact of the head with the magnetic disk as well as head crash. As described below, to produce such an effect, it is necessary to set the visual angle θ₂ of the head slider 76 located in the inner peripheral portion, to 10° or more.

As shown in Table 1, magnetic recording and reproducing apparatuses are produced by combining discrete track media of a plurality of sizes with head sliders of a plurality of sizes. Read/write experiments are performed on the magnetic recording and reproducing apparatuses. The track pitch is set at 250 nm for all the discrete track media. The recesses between the magnetic patterns have a depth of 20 nm. The guard bands have a groove structure in which no nonmagnetic material is filled therein.

In the apparatuses A and B, 2.5-inch media is used. In this media, the radial position of the innermost recording track is 12 mm, and the radial position of the outermost recording track is 32 mm. The head slider used in the apparatus A has a long side length (in the track direction) of 2.05 mm and a short side length (in the cross-track direction) of 1.6 mm. The head slider used in the apparatus B has a long side length (in the track direction) of 5.0 mm and a short side length (in the cross-track direction) of 3.5 mm, the size of which is larger than that the former.

In the apparatus A, the visual angle for the head slider is 9.8° on the inner periphery and 3.7° on the outer periphery. In the apparatus B, the visual angle for the head slider is 24.6° on the inner periphery and 9.0° on the outer periphery. As shown in Table 1, the apparatus B exhibits a lower error rate than the apparatus A for both the innermost and outermost peripheries. In the apparatus A, on the outermost periphery, the head is vibrated by its vertical movement caused by the recesses and protrusions present on the surface of the discrete media. On the innermost periphery, the head can be brought into contact with the media. As a result, the error rate is increased.

In the apparatus C, 0.85-inch media is used. In this media, the radial position of the innermost recording track is 9.7 mm, and the radial position of the outermost recording track is 4.7 mm. The head slider used in the apparatus C has a long side length (in the track direction) of 0.85 mm and a short side length (in the cross-track direction) of 0.7 mm.

In the apparatus C, the visual angle for the head slider is 10.42° on the inner periphery and 5.03° on the outer periphery. Like the apparatus B, the apparatus C exhibits a low error rate for both the innermost and outermost peripheries.

Table 1 indicates that the visual angle θ₁ of the head slider 76 located on the outer periphery should be 5° or more and that the visual angle θ₂ of the head slider 76 located on the inner periphery should be 10° or more.

TABLE 1

| | | | | Head slider | | | |
|---|---|---|---|---|---|---|---|
| | | | | size | | | |
| | Media | | | Long | Short | Visual | |
| | Size | Radial position | | side | side | angle | Error |
| | (inch) | (mm) | | (mm) | (mm) | (deg) | rate |
| Apparatus | 2.5 | Outer | 32 | 2.05 | 1.6 | 3.67 | 3.00 |
| A | | periphery | | | | | E-04 |
| | | Inner | 12 | 2.05 | 1.6 | 9.84 | 7.00 |
| | | periphery | | | | | E-04 |
| Apparatus | 2.5 | Outer | 32 | 5.0 | 3.5 | 8.99 | 5.00 |
| B | | periphery | | | | | E-07 |
| | | Inner | 12 | 5.0 | 3.5 | 24.62 | 5.00 |
| | | periphery | | | | | E-07 |
| Apparatus | 0.85 | Outer | 9.7 | 0.85 | 0.7 | 5.03 | 9.00 |
| C | | periphery | | | | | E-07 |
| | | Inner | 4.7 | 0.85 | 0.7 | 10.42 | 1.00 |
| | | periphery | | | | | E-06 |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording and reproducing apparatus comprising:
a magnetic recording media having discrete tracks formed of concentric magnetic patterns; and
a head slider having a read/write head,
wherein, when the head slider is located on an outermost recording zone of the magnetic recording media, a visual angle for the head slider as viewed from a rotation center of the magnetic recording media is 5° or more.

2. The apparatus according to claim 1, wherein the outermost recording zone of the magnetic recording media is located at a distance of at most 10 mm from the rotation center of the magnetic recording media, and the length of the head slider along a track direction is 0.85 mm or less.

3. The apparatus according to claim 1, wherein the magnetic patterns forming the tracks comprise a soft underlayer and a perpendicular recording layer.

4. The apparatus according to claim 1, wherein the magnetic patterns forming the tracks are separated by a nonmagnetic material.

5. A magnetic recording and reproducing apparatus comprising:
a magnetic recording media having discrete tracks formed of concentric magnetic patterns; and
a head slider having a read/write head,
wherein, when the head slider is located on an innermost recording zone of the magnetic recording media, a visual angle for the head slider as viewed from a rotation center of the magnetic recording media is 10° or more.

6. The apparatus according to claim 5, wherein the innermost recording zone of the magnetic recording media is located at a distance of at most 5 mm from the rotation center of the magnetic recording media, and the length of the head slider along a track direction is 0.85 mm or less.

7. The apparatus according to claim 5, wherein the magnetic patterns forming the tracks comprise a soft underlayer and a perpendicular recording layer.

8. The apparatus according to claim 5, wherein the magnetic patterns forming the tracks are separated by a nonmagnetic material.
